(19) United States
(12) Patent Application Publication
(10) Pub. No.: US 2005/0037108 A1
(43) Pub. Date: Feb. 17, 2005

(54) Methods and compositions for enhancing palatability of animal feed using tetrapotassium pyrophosphate

(76) Inventors: Charles Lin, Decatur, AL (US); Larry Maxfield, Decatur, AL (US); Tony R. Ponter, Falkville, AL (US)

Correspondence Address: Hovey Williams LLP, Suite 400, 2405 Grand Blvd., Kansas City, MO, 64108, US

(21) Appl. No.: 10/641,620

(22) Filed: Aug. 14, 2003

(51) Int. Cl. A01K 1/00

(52) U.S. Cl. 426/2

(57) ABSTRACT

Compositions and methods for enhancing the palatability of dry and semi-dry animal feed compositions, particularly extruded cat food compositions, are described. In one embodiment, the palatability enhancer is a dry cat food coating including tetrapotassium pyrophosphate at about 0.1% to about 1.0% by weight of the finished pet food product. In the case of extruded pet food products, the palatability enhancer is applied after the extrusion process to the extruded particles or pieces of pet food.

### BACKGROUND OF THE INVENTION

1. Field of the Invention

This invention relates generally to methods and compositions for enhancing the palatability of animal feeds, and more particularly to compositions and methods for enhancing the palatability of dry and semi-dry cat food.

2. Description of the Prior Art

Pet food manufacturers have a long-standing desire to provide foods which combine high nutritional value, and resistance to decomposition and bacterial contamination, with low production costs. In addition, and with particular regard to cat foods, pet food manufacturers desire a high degree of palatability which can be attained at low cost.

The three main types of pet foods embody the desired characteristics to varying degrees. Canned or high-moisture (greater than 50% moisture) foods are typically all meat and therefore generally highly palatable to animals. However, such foods are typically costly to produce and package, require the use of preservatives to inhibit decomposition and contamination, and are relatively less nutritious per unit weight than other pet food products. Dry or low-moisture content pet foods (less than 15% moisture) are generally highly nutritious, may be inexpensively packaged, and are highly convenient to store and use. However, dry or low-moisture foods are generally the least palatable of pet foods. Semi-dry or intermediate moisture content pet foods (about 15% to about 50% moisture) are generally more palatable than dry foods, have higher nutritional value, and are more inexpensively packaged and more conveniently used than high moisture foods. However, intermediate moisture content foods may be more susceptible to bacterial contamination than dry pet foods, and are generally less palatable than high moisture content foods.

Dry and semi-dry foods are generally preferred by manufacturers and pet owners alike because such foods are more convenient to store and use, and because of the higher nutritional content than high-moisture pet foods. However, many animals, and particularly cats, are picky eaters desiring a high degree of palatability. There remains a need for a low-moisture pet food with a high degree of palatability.

Known palatability enhancers for low moisture pet foods include various surface coating compositions. For example, known palatability enhancers include surface coatings of phosphoric acid; a combination of fat with hexamic, phosphoric or citric acid; and a mixture of phosphoric acid and citric acid. Palatability may also be enhanced by the application of liquid or dry flavorings as a coating. Liquid or dry animal digest coatings are widely used to enhance palatability, and animal digest is also used in a liquid combination with phosphoric acid. Dry animal digest may be used in a two step coating process with liquid phosphoric acid. Dry application of sodium acid phosphate, which may be used in combination with animal digest, is also known.

U.S. Pat. Nos. 6,254,920 and 6,350,485, incorporated by reference herein, disclose palatability enhancing compositions which comprise amounts of tetrasodium pyrophosphate in addition to animal digest. These compositions were shown to increase the palatability of dry pet food over the use of liquid animal digest alone. However, the use of tetrasodium pyrophosphate increases the animal's daily sodium intake. While typically, the presence of other important minerals such as potassium is relatively small thereby requiring the inclusion of additional ingredients such as potassium chloride to fulfill nutrition requirements established by the Association of American Feed Control Officials (AAFCO).

It would be desirable to provide a composition and method for further enhancing the palatability of dry and semi-dry animal feed without the addition of extra sodium to the animal's diet. It would also be desirable to provide such a composition with a high degree of palatability for cats. It would be further desirable to provide such a composition and method which enhances dry and semi-dry animal feed palatability at a relatively low production cost. It would be still further desirable to provide such a palatability enhancer which comprises essential minerals thereby reducing or eliminating the need for supplemental ingredients.

### SUMMARY OF THE INVENTION

These and other objects may be attained by an animal feed palatability enhancer which includes tetrapotassium pyrophosphate. The palatability enhancer, and methods for enhancing the palatability of animal feeds, generally relate to dry and semi-dry animal feeds including a nutritionally balanced mixture of proteinaceous and farinaceous materials. Generally, the palatability enhancer is a dry formulation including from about 0.1% up to about 99% by weight tetrapotassium pyrophosphate, more preferably from about 15-40% by weight, and most preferably from about 25-35% by weight. In one embodiment, the palatability enhancer is formulated by adding tetrapotassium pyrophosphate in dry powdered form to a dry composition for application to a dry animal feed. The dry composition typically also includes readily commercially available ingredients such as dried whey, dried animal digest, and yeast. The amount of tetrapotassium pyrophosphate added to the dry composition is adjusted so that tetrapotassium pyrophosphate contributes up to about 1.5% by weight, more preferably up to about 1.0% by weight, and most preferably up to about 0.75% by weight of the finished dry animal feed. However, in most preferred embodiments, the tetrapotassium pyrophosphate contributes from about 0.1-1.0% by weight of the finished product

In use and in one embodiment, the palatability enhancer is applied to particles or pieces of extruded, dry or semi-dry cat food. More specifically, the particles or pieces are added to a coating drum and molten animal fat and other liquids are sprayed over the dry pieces. The palatability enhancer is applied to the pieces and the pieces are tumbled in the drum to thoroughly coat the pieces.

The palatability enhancer improves the palatability of dry and semi-dry animal feeds. The palatability enhancer is particularly effective for enhancing the palatability to cats of dry and semi-dry cat foods. Further, the palatability enhancer may be added to commercially available dry and semi-dry cat foods or other pet and animal foods at a relatively low production cost.

The palatability enhancer generally is a dry composition including from about 0.1% up to about 99% by weight tetrapotassium pyrophosphate. The palatability enhancer is generally externally applied, using dry application methods, to commercially available, dry or semi-dry animal feeds.

More specifically, the palatability enhancer and methods for enhancing the palatability of dry and semi-dry animal feeds, generally relate to a nutritionally balanced mixture of proteinaceous and farinaceous materials having a moisture content of about 50% or less by weight. Such mixtures are known as dry or semi-dry animal feeds to those skilled in the art, and the palatability enhancer is applied to pieces of the dry or semi-dry food. The animal feed compositions described herein are not intended to be limited to a specific listing of ingredients because such ingredients will depend on such factors as, for example, the desired nutritional balance for the specific type of pet, and availability of ingredients to the manufacturer. In addition to the proteinaceous and farinaceous materials, the animal feed composition generally may include vitamins, minerals, and other additives such as flavorings, preservatives, emulsifiers and humectants. The nutritional balance, including the relative proportions of vitamins, minerals, fat, protein and carbohydrate, is determined according to dietary standards known in the veterinary art. For example, the nutritional balance of a cat food composition is determined according to the known dietary requirements for cats.

The proteinaceous material may include any material having a protein content of at least about 15% by weight including vegetable proteins such as soybean, cotton seed, and peanut; animal proteins such as casein, albumin, and fresh animal tissue including fresh meat tissue and fresh fish tissue; and dried or rendered meals such as fish meal, poultry meal, meat meal, bone meal and the like. Other types of suitable proteinaceous materials include wheat gluten or corn gluten, and microbial proteins such as yeast.

The farinaceous material may be defined as any material having a protein content of less than about 15% by weight and containing a substantial proportion of starches or carbohydrates, including grains such as corn, milo, alfalfa, wheat, barley, rice, soy hulls, and other grains having low protein content. In addition to the proteinaceous and farinaceous materials, other materials such as whey and other dairy by-products, as well as other carbohydrates may be added. In addition, known flavorings including, for example, corn syrup or molasses, may be added.

In one exemplary embodiment, the palatability enhancer is applied to a dry cat food composition. Generally, the term cat food composition as used herein applies to commercially sold, nutritionally balanced food compositions which are intended to provide substantially the sole diet for a cat. Thus, such compositions may be described as having a minimum protein content at which cat health is maintained. However, the minimum protein content of the food varies according to the age and breeding status for the animal. For example, a nutritionally balanced cat food composition for breeding females and kittens requires a minimum crude protein content of at least about 30% by weight on a dry matter basis. A nutritionally balanced cat food composition for non-breeding and adult cats requires a minimum crude protein content of about 26% by weight on a dry matter basis. More typically, the crude protein content of commercially available cat food compositions for adult, non-breeding cats is about 30% by weight on a dry matter basis, to insure that the food meets the nutritional requirements of any cat.

For example, a typical formula well known in the art for a dry cat food composition to which the palatability enhancer is applied is as follows (in percent by weight): about 0-70% grain-based meal or flour, such as corn, wheat, barley or rice; about 0-30% animal by-product meal, such as poultry or beef meal; about 0-25% corn gluten meal; about 0-25% fresh animal tissue, such as poultry or beef tissue; about 0-25% soybean meal or flour; about 0-10% animal fat; about 0-20% seafood-based meal; about 0-25% fresh fish tissue; about 0-10% high fructose corn syrup; about 0-10% dried molasses; about 0-1.5% phosphoric acid; and about 0-1.5% citric acid. Vitamins and minerals are added according to known American Association of Feed Control Officials (AAFCO) Cat Food Nutrient profiles, and include calcium carbonate, potassium chloride, sodium chloride, choline chloride, taurine, zinc oxide, ferrous sulfate, vitamin E, vitamin A, vitamin B12, vitamin D3, riboflavin, niacin, calcium pantothenate, biotin, thiamine mononitrate, copper sulfate, folic acid, pyroxidine hydrochloride, calcium iodate, and menadione sodium bisulfite complex (a source of vitamin K activity).

In addition, the palatability enhancer relates to other animal feeds and animal foods in general without regard to the protein content which typically varies according to species, breeding status, and age, among other factors. For example, the palatability enhancer may be used with a dry or semi-dry dog food composition for non-breeding, adult dogs, which requires a minimum protein content of about 18% by weight on a dry matter basis. Similarly, the palatability enhancer may be applied to a dry or semi-dry puppy food having a minimum protein content of about 22% by weight on a dry matter basis. The palatability enhancer may also be used with other dry and semi-dry foods of varying protein content, and with foods for other animals such as livestock and research animals.

The palatability enhancer generally includes tetrapotassium pyrophosphate and is formulated as a dry mixture in powdered, granulated or encapsulated form. Tetrapotassium pyrophosphate is available in dry, powdered form from, for example, Astaris LLC, St. Louis, Mo., and is combined with other dry ingredients including known palatability enhancing ingredients and preservatives. For example, other suitable ingredients for the palatability enhancer include various nucleotides such as inosine monophosphate (IMP), guanosine triphosphate (GTP) and adenosine triphosphate (ATP); amino acids such as alanine and lysine; other inorganic salts such as NaCl, monosodium phosphate, and dicalcium phosphate; and dairy by-products such as whey, microbial proteins such as yeast, and animal by-products digest. The palatability enhancer includes about 0.1% up to about 99% by weight tetrapotassium pyrophosphate. In one embodiment, the amount of tetrapotassium pyrophosphate is adjusted so that tetrapotassium pyrophosphate contributes about 0.1% to about 1.0% by weight to the finished animal feed, depending on the relative amount of the palatability enhancer added to the finished animal feed. Generally, the palatability enhancer contributes from about 0.5% to about 3.0% by weight to the finished cat food product. However, both the exact proportion of tetrapotassium pyrophosphate in the palatability enhancer, as well as the relative proportion of the palatability enhancer to the finished cat food product, may be varied and are limited by such factors as relative availability of the ingredients, cost, and health of the animal. In addition, the palatability enhancer described herein is not intended to be limited to a specific listing of ingredients because such ingredients will similarly depend on availability and cost of ingredients to the manufacturer.

To make a dry formulation of the palatability enhancer, for example, commercially available dry ingredients, including tetrapotassium pyrophosphate, various nucleotides, amino acids, inorganic salts and organic materials are combined in the desired proportions in a batch mixer and blended to homogeneity. In one embodiment, a dry formulation of the palatability enhancer typically includes about 15-40 weight % tetrapotassium pyrophosphate, about 0.1-3.0 weight % amino acid, about 20-55 weight % animal by-products such as dried animal digest, and about 20-50 weight % microbial protein such as brewer's yeast.

To make a liquid formulation of the palatability enhancer, for example, commercially available liquid ingredients are combined in a mixer. Wet ingredients such as animal tissue are ground or emulsified to a slurry and the liquid ingredients are combined with the slurry. A commercially available protease is added to the slurry to hydrolyze the proteins, and later inactivated with heat, acid or another method. Preservatives such as sorbates are also added to the slurry. Water is added to adjust the viscosity and the solids content of the slurry to between about 10% and 50% to facilitate the application process as described below. The tetrapotassium pyrophosphate, and other dry ingredients as desired, are added to the slurry prior to application. A liquid formulation of the palatability enhancer includes about 5-45 weight % tetrapotassium pyrophosphate; about 1-50 weight % animal tissue such as beef hearts or livers, or chicken hearts or livers; about 0.1-3.0 weight % amino acid such as alanine or lysine; about 0.1-1.0 weight % preservatives such as sorbic acid and about 0.1-2.0 weight % enzymes such as protease. For example, one embodiment of the liquid formulation includes about 14-20 weight % tetrapotassium pyrophosphate.

In use, the palatability enhancer is applied to the particles or pieces of dry or semi-dry animal feed such as, for example, dry extruded kibbles as known in the art. The palatability enhancer is applied, for example, by spraying or dusting onto the particles or pieces of the food. More specifically, to make a cat food composition to which the palatability enhancer is applied, proteinaceous and farinaceous materials and additional desired materials as described above are combined to form an admixture and are well blended. The admixture is then transferred to a steam conditioner and subjected to steam and moisture to adjust the moisture content of the admixture to between about 20% and 40% by weight. The conditioned admixture is then cooked under conditions of elevated temperature and pressure in an extruder such as a single screw extruder. The extruder may include a die having a particular shape, such as a fish, cross or circle. The product is segmented into discrete particles or pieces by a rotating cutting knife as the product is extruded.

The particles or pieces are conveyed to a forced air drying system which raises the temperature of the pieces to about 140° F., and reduces the moisture level to about 8% by weight. The dried particles or pieces are then transferred by bulk conveyor to a coating drum and sprayed with animal fat. Other liquids such as, for example, citric acid or phosphoric acid may alternatively be applied to the pieces, or applied in addition to the animal fat. The pieces are then sprayed or dusted with the palatability enhancer, and tumbled to thoroughly coat the pieces with the palatability enhancer. The pieces are then cooled to ambient temperature and packaged.

It is also within the scope of the present invention for the palatability enhancer to be incorporated into the animal feed itself. The animal feed may be incorporated into the animal feed, for example, during formulation of the feed product, or during extrusion processing thereof.

### DETAILED DESCRIPTION OF THE PREFERRED EMBODIMENT

The following examples set forth palatability enhancing compositions according to the present invention. It is to be understood, however, that these examples are provided by way of illustration and nothing therein should be taken as a limitation upon the overall scope of the invention.

### EXAMPLE 1

In this example, a dry cat food palatability enhancer was produced. First, two digest ingredients were prepared in order to form a digest which would ultimately be used in the palatability enhancer.

The first digest was an organ meat digest. The formulation for the organ meat digest is set forth in Table 1. The preferred amounts given were employed in the present example.

TABLE 1

| | | Preferred |
|---|---|---|
| Ingredient | Broad range (wt. %) | amount (wt. %) |
| Chicken heart and liver | 40-80% | 48.00% |
| Pork liver | 10-50% | 48.00% |
| Steam | 3.5-4.5% | 4.00% |
| Proteolytic enzyme | 0.05-0.5%¹ | 0.18%² |
| Citric acid | 0.01-0.1% | 0.03% |
| Dadex antioxidant (BHA/citric | 0.001-.1% | 0.01% |
| acid/propyl gallat) | | |
| Sodium hydroxide, 50% | 0-1.0% | —² |

¹Nova Alcalase 2.4 or Gennencor 2.4
²Papain used, no NaOH 50% required.

Frozen chicken and pork meat (3-5 inch pieces) were passed through a prebreaker and then ground with a meat grinder through a die plate having openings of no more than ¼ inch. The ground meat was heated to between 125-135° F. Sodium hydroxide, enzyme, citric acid, and antioxidant were then added. As noted in Table 1, Papain was used as the enzyme. In so doing, the quantity of sodium hydroxide was omitted. The temperature of the mixture was held at 125-135° F. for 50-60 minutes. The digest was then pumped through an emulsifier in order to grind any undigestable materials. Any remaining undigestable materials were then removed from the digest by passing the digest through a screen. The digest was then heated to 185-195° F. for 40-60 seconds to sterilize the digest and deactivate the enzyme. The digest was stored in a jacketed tank and kept at a temperature of at least 155° F. until dry. During the storage step, the digest should not be held at this temperature for longer than 36 hours.

The second digest is a chicken viscera digest, the formula of which is given in Table 2. The preferred amounts were used in the present formulation.

TABLE 2

| Ingredient | Broad range (wt. %) | Preferred amount (wt. %) |
|---|---|---|
| Chicken viscera | 90.0-99.8% | 94.80% |
| Steam | 4.5-5.5% | 5.00% |
| Dadex antioxidant | 0.001-0.1% | 0.02% |
| Proteolytic enzyme | 0.05-0.5%¹ | 0.18%² |

¹Nova Alcalase 2.4 or Gennencor 2.4
²Liquidpanol-T200 (Papain)

The chicken viscera was received at a temperature under 40° F. and then heated to 100° F. The antioxidant was immediately added in order to prevent oxidation of fats. The enzyme was added and the viscera heated to 165° F. and held for 4-5 hours. Undigested materials were removed from the digest by screening.

The meat organ digest and chicken viscera digest were used to create a digest formulation which would comprise one ingredient of the final cat food palatability enhancer. The formulation for this digest is given in Table 3, with the preferred amount being used for purposes of this example.

TABLE 3

| | | Preferred |
|---|---|---|
| Ingredient | Broad range (wt. %) | amount (wt. %) |
| Organ meat digest | 85.0-90.0% | 86.38% |
| Chicken viscera digest | 0-10% | 9.00% |
| Xylose | 1-5% | 1.00% |
| Steam | 1.0-2.5% | 1.00% |
| Flow agent (Zeosyl 110SD) | 0.1-1.5% | 0.80% |
| Egg yolk solid | 0.55-0.95% | 0.79% |
| Glycine | 0.45-0.95% | 0.72% |
| Ascorbic acid | 0.10-0.25% | 0.15% |
| Thiamine HCL | 0.05-0.10% | 0.08% |
| DL-Methionine | 0.05-0.10% | 0.06% |
| Cysteine HCL | 0.01-0.05% | 0.02% |

All ingredients (except for the flow agent) were blended in a kettle at 165° F. The blend was transferred into a surge vessel and held at 165° F. for 90-125 minutes while awaiting spray drying. The mixture was homogenized at 2000-2500 psi using a high pressure pump with a homogenizing valve. The mixture was fed through a spray drier whicle adjusting the sprayer feed rate, air temperature, air flow, and spray pressure to achieve a particle size of 70% through a 60M screen and a moisture content of less than 4.0%. The flow agent Zeosyl was added after drying in order to improve the flow characteristics of the dried digest formulation.

The dried digest formulation was then used to create the dry cat food palatability enhancer. The formulation of the palatability enhancer is set forth in Table 4.

TABLE 4

| | | Preferred |
|---|---|---|
| Ingredient | Broad range (wt. %) | amount (wt. %) |
| Dried digest formulation | 20.00-55.00% | 34.62% |
| Brewtech yeast | 20.00-50.00% | 38.07% |
| Tetrapotassium pyrophosphate | 15-40% | 26.50% |
| L-alanine | 0.1-1% | 0.80% |
| Flow aid (Zeosyl 110SD) | 0.05-0.5% | 0.28% |

All ingredients were blended completely and then transferred into a surge vessel to await packaging.

Table 5 summarizes the preferred specifications for the organ meat digest, chicken viscera digest, and palatability enhancers described above.

TABLE 5

| | Organ meat | Chicken viscera | |
|---|---|---|---|
| Specification | digest | digest | Palatability enhancer |
| Dietary energy (Cal/kg) | 4200 Cal/kg | 2300 Cal/kg | 2850 Cal/kg |
| Protein (wt. %) | 60.00-65.30% | 16.50-40.00% | 38.00-46.00% |
| Fat (wt. %) | 20.00-21.50% | 3.00-30.00% | 7.00-13.00% |
| Moisture (wt. %) | 7.50-8.90% | 4.80-6.50% | 3.00-7.50% |
| Ash (wt. %) | 6.00-7.55% | 5.60-7.60% | 25.00-30.50% |
| Crude fiber (wt. %) | 0% | 0% | 0% |
| Particle size (20M) | 100% thru | 100% thru | 100% thru |
| Particle size (60M) | 70% thru | 70% thru | 70% thru |
| Color | Brown | Brown | Brown |
| Odor | Digest/liver | Digest | Digest/liver |
| Standard plate count | 50,000/mg max | 50,000/mg max | 50,000/mg max |
| Coliform | 10/g max | 10/g max | 10/g max |
| E. Coli | None detected | None detected | None detected |
| Salmonella | None detected | None detected | None detected |
| Yeast and mold | 100/g max | 100/g max | 100/g max |

### EXAMPLE 2

In this example, the impact of tetrapotassium pyrophosphate on the palatability of dry cat food was compared with a prior art flavor system disclosed in U.S. Pat. Nos. 6,254,920 and 6,350,485 (comprising tetrasodium pyrophosphate). Tetrapotassium pyrophosphate was incorporated into palatability enhancers made in accordance with Table 4 above at levels of 10%, 15%, 20%, 25%, 30%, and 35% by weight. The palatability enhancers were then coated on to Meow Mix® Original dry cat food. The same cat food was also coated with the prior art coating for use as a comparative. The prior art coating comprised 20.00% by weight tetrasodium pyrophosphate, equivalent to 0.500% by weight of the cat food product and comparable amounts of animal digest. Each cat food having a coating including tetrapotassium pyrophosphate was compared to the cat food having a coating including tetrasodium pyrophosphate by feeding each food to 20 cats for 2 days. The cats' preferences for each food are noted in Table 6 in terms of percent of total food consumption.

TABLE 6

| Concentration of tetrapotassium | | |
|---|---|---|
| pyrophosphate¹ | | Tetrapotassium pyrophospate |
| Finished product | Palatability | coated food consumed as |
| (wt. %) | enhancer (wt. %) | percentage of total food consumed |
| 0.250% | 10.00% | 30.29% |
| 0.375% | 15.00% | 28.24% |
| 0.500% | 20.00% | 37.78% |
| 0.625% | 25.00% | 50.94% |
| 0.750% | 30.00% | 52.45% |
| 0.875% | 35.00% | 38.89% |

¹Tetrapotassium pyrophosphate manufactured by Escalade, Sarasota, Florida, at 96.27% purity.

From the above results, cat food coated with 25% and 30% concentration tetrasodium pyrophosphate palatability enhancers exhibited equivalent palatability to cat food coated with the comparative composition comprising tetrasodium pyrophosphate as the cats consumed roughly equal portions of both.

### EXAMPLE 3

In this example, an optimal tetrapotassium pyrophosphate level for the inventive palatability enhancer was determined. The procedure employed was almost identical to that of Example 2 except that two additional concentrations of tetrapotassium pyrophosphate were tested, 26% and 28% by weight. Again, the same comparative coating comprising 20.00% by weight tetrasodium pyrophosphate was employed as the comparative composition. The results are noted in Table 7.

TABLE 7

| Concentration of tetrapotassium | | |
|---|---|---|
| pyrophosphate¹ | | Tetrapotassium pyrophospate |
| Finished product | Palatability | coated food consumed as |
| (wt. %) | enhancer (wt. %) | percentage of total food consumed |
| 0.250% | 10.00% | 36.62% |
| 0.375% | 15.00% | 38.95% |
| 0.500% | 20.00% | 46.61% |
| 0.625% | 25.00% | 45.77% |
| 0.650% | 26.00% | 59.00% |
| 0.700% | 28.00% | 60.00% |
| 0.750% | 30.00% | 51.80% |
| 0.875% | 35.00% | 51.13% |

¹Tetrapotassium pyrophosphate anhydrous manufactured by Astaris LLC, St. Louis, Missouri, at 97% purity.

The above data demonstrates that cat food comprising a palatability enhancer having including 26-28% by weight tetrapotassium pyrophosphate gave superior results over the comparative formula.

### EXAMPLE 4

The information gathered from the previous examples was used to create a new flavor system for cat food. First, a new digest formulation was prepared using the organ meat digest and chicken viscera digest noted in Tables 1 and 2, respectively. The composition of this new digest formulation is set forth in Table 8. Again, the particular recipe employed is given in the “preferred amount” column.

TABLE 8

| | | Preferred |
|---|---|---|
| Ingredient | Broad range (wt. %) | amount (wt. %) |
| Organ meat digest | 86.7-96.7% | 88.20% |
| (from Table 1) | | |
| Chicken viscera digest | 0-10% | 9.00% |
| (from Table 2) | | |
| Xylose | 1-5% | 1.00% |
| Steam | 1.0-2.5% | 1.00% |
| Flow agent (Zeosyl 110SD) | 0.1-1.5% | 0.80% |

All ingredients, except for the flow agent, were blended together in a kettle at 165° F. and then transferred into a surge vessel while awaiting spray drying. The mixture was held in the surge vessel for 65-125 minutes at 165° F. followed by homogenization at 2000-2500 psi using a high pressure pump. The spray dryer feed rate, air temperature, air flow, and spray pressure were adjusted to achieve a particle size of 70% passaged through a 60M screen with under 4.0% moisture. Lastly, the flow agent was added to improve the flow characteristics of the dried digest formulation.

The dried digest formulation was then used to create three different palatability enhancers, each containing 26.50% tetrapotassium pyrophosphate. The three formulations are set forth in Table 9.

TABLE 9

| | Palatability enhancer #1 | | Palatability enhancer #2 | | Palatability enhancer #3 | |
|---|---|---|---|---|---|---|
| | Broad range | Preferred amount | Broad range | Preferred amount | Broad range | Preferred amount |
| Ingredient | (wt. %) | (wt. %) | (wt. %) | (wt. %) | (wt. %) | (wt. %) |
| Dried digest | 20.00-55.00% | 34.62% | 20.00-55.00% | 29.62% | 20.00-55.00% | 24.62% |
| (from Table 8) | | | | | | |
| Brewtech yeast | 20.00-50.00% | 38.07% | 20.00-50.00% | 33.07% | 20.00-50.00% | 28.07% |
| Tetrapotassium | 26.00-28.00% | 26.50% | 26.00-28.00% | 26.50% | 26.00-28.00% | 26.50% |
| pyrophosphate | | | | | | |
| L-Alanine | 0.1-1.00% | 0.80% | 0.1-1.00% | 0.80% | 0.1-1.00% | 0.80% |
| Fish protein GS | — | — | 5.00-15.00% | 10.00% | 5.00-15.00% | 20.00% |
| 90 | | | | | | |
| Flow aid (Zeosyl | 0.05-0.5% | 0.28% | 0.05-0.5% | 0.28% | 0.05-0.5% | 0.28% |
| 110SD) | | | | | | |

The three palatability enhancers were then coated onto Meow Mix® Original dry cat food and compared to the same cat food comprising a palatability enhancing coating according to U.S. Pat. Nos. 6,254,920 and 6,350,485 (coating comprising 20.00% tetrasodium pyrophosphate, equivalent to 0.500% of the finished product). The cat food was fed to 20 cats for two days. The results are given in Table 10.

TABLE 10

| | Tetrapotassium pyrophospate |
|---|---|
| | coated food consumed as |
| Flavoring system | percentage of total food consumed |
| Palatability enhancer #1 | 62.00% |
| Palatability enhancer #2 | 71.00% |
| Palatability enhancer #3 | 75.00% |

The data in Table 10 demonstrates a significant improvement in palatability over the prior art palatability enhancer comprising tetrasodium pyrophosphate. The palatability enhancers of the present invention provide increased palatability over the prior art composition as well as providing the benefit of decreasing the cat's sodium intake while at the same time inserting additional potassium into the cat's diet.

1. A palatability enhancing composition for an animal feed, said composition comprising tetrapotassium pyrophosphate in an amount effective to enhance palatability and at least one additional ingredient selected from the group consisting of animal by-products, microbial proteins, dairy by-products, amino acids, and carbohydrates.

2. The composition of claim 1, said composition comprising from about 15-40% by weight tetrapotassium pyrophosphate.

3. The composition of claim 1, wherein said composition is dry.

4. The composition of claim 1, wherein said composition is liquid.

5. A palatability enhancing composition for an animal feed comprising:
from about 15-40% by weight tetrapotassium pyrophosphate;
from about 20-50% by weight microbial protein; and
from about 20-55% by weight animal by-product.

6. The composition of claim 5, said composition further comprising one or more ingredients selected from the group consisting of carbohydrates, dairy by-products, and amino acids.

7. The composition of claim 5, said microbial protein comprising yeast.

8. The composition of claim 5, said composition comprising from about 25-35% by weight tetrapotassium pyrophosphate.

9. The composition of claim 5, wherein said composition is dry.

10. The composition of claim 5, wherein said composition is liquid.

11. In an animal feed, the improvement comprising a palatability enhancer including tetrapotassium pyrophosphate in an amount effective to enhance the palatability of the animal feed.

12. The feed of claim 11, wherein said palatability enhancer comprises from about 15-40% by weight tetrapotassium pyrophosphate.

13. The feed of claim 11, said palatability enhancer comprising up to about 1.5% by weight of the feed.

14. The feed of claim 11, said feed being an extruded animal feed composition.

15. The feed of claim 11, said palatability enhancer comprising one or more ingredients selected from the group consisting of animal by-products, microbial proteins, dairy by-products, amino acids, and carbohydrates.

16. An animal feed comprising respective quantities of carbohydrate, protein, fat, and a palatability enhancer including tetrapotassium pyrophosphate in an amount effective to enhance the palatability of said feed.

17. The feed of claim 16, said palatability enhancer comprising from about 15-40% by weight tetrapotassium pyrophosphate.

18. The feed of claim 16, said palatability enhancer comprising up to about 1.5% by weight of the feed.

19. The feed of claim 16, said feed being an extruded animal feed composition.

20. The feed of claim 16, said palatability enhancer comprising one or more ingredients selected from the group consisting of animal by-products, microbial proteins, dairy by-products, amino acids, and carbohydrates.

21. A method for enhancing the palatability of an animal feed, said method comprising the step of applying a palatability enhancing composition including tetrapotassium pyrophosphate and at least one member selected from the group consisting of an amino acid, an animal by-product, and a microbial protein, to said animal feed.

22. The method of claim 21, wherein the animal feed is an extruded animal feed.

23. The method of claim 21, wherein said palatability enhancing composition is applied to said animal feed in a quantity sufficient to contribute up to about 1.5% by weight of tetrapotassium pyrophosphate to said animal feed.

24. The method of claim 21, wherein said palatability enhancing composition is dry and the step of applying the palatability enhancing composition to the animal feed comprises dusting the palatability enhancing composition onto the animal feed.

25. A method of improving the palatability of an animal feed comprising applying to said animal feed a palatability enhancing composition including tetrapotassium pyrophosphate, in a quantity sufficient to contribute up to about 1.5% by weight of tetrapotassium pyrophosphate to said animal feed.

26. The method of claim 25, wherein the animal feed is an extruded animal feed.

27. The method of claim 25, said palatability enhancing composition comprises from about 15-40% by weight tetrapotassium pyrophosphate.

28. The method of claim 25, said palatability enhancing composition comprising one or more ingredients selected from the group consisting of an amino acid, an animal by-product, and a microbial protein, to said animal feed.

29. The method of claim 25, wherein said palatability enhancing composition is dry and the step of applying the palatability enhancing composition to the animal feed comprises dusting the palatability enhancing composition onto the animal feed.

30. A method for enhancing the palatability of an animal feed, said method comprising:
combining tetrapotassium pyrophosphate, animal by-product, and microbial protein in a mixer;
blending the tetrapotassium pyrophosphate, animal by-product and microbial protein to homogeneity to form a palatability enhancing composition; and
applying said palatability enhancing composition to an animal feed.

31. The method of claim 30, said palatability enhancing composition comprising from about 15-40% by weight tetrapotassium pyrophosphate, from about 20-55% by weight animal by-product, and from about 20-50% by weight microbial protein.

32. The method of claim 30, said animal feed being an extruded animal feed.

33. The method of claim 30, wherein said palatability enhancing composition is dry and the step of applying the palatability enhancing composition to the animal feed comprises dusting the palatability enhancing composition onto the animal feed.
